(19) United States
(12) Patent Application Publication
(10) Pub. No.: US 2015/0373072 A1
(43) Pub. Date: Dec. 24, 2015

(54) Remote Streaming of Media Content

(71) Applicants: David Moricca, Brooklyn, NY (US); Benjamin Aaron Davenport, Brooklyn, NY (US); Michael E. Orth, Brentwood, TN (US)

(72) Inventors: David Moricca, Brooklyn, NY (US); Benjamin Aaron Davenport, Brooklyn, NY (US); Michael E. Orth, Brentwood, TN (US)

(21) Appl. No.: 14/720,065

(22) Filed: May 22, 2015

Related U.S. Application Data
(60) Provisional application No. 62/002,317, filed on May 23, 2014.

(51) Int. Cl. H04L 29/06; H04L 29/08

(52) U.S. Cl. CPC H04L 65/604; H04L 67/32

(57) ABSTRACT

An example system for streaming media content includes: a data communication network; a source venue for generating audio and/or video data stream, the source venue in communication with the data communication network; and at least one recipient venue, the at least one recipient venue in communication with the data communication network; the source venue is configured to send the audio and/or video data stream to the at least one recipient venue through the data communication network.

### BACKGROUND

Venues such as night clubs, bars, and restaurants often hire disc jockeys (hereinafter “DJs”) or bands to play music at their venues. Oftentimes, these venues must provide the DJ with space and equipment, including turntables, mixers, headphones, computers, etc. Another burden on venues is that they must either have a DJ on staff or regularly invite guest DJs to play at their venue. Additionally, popular DJs may be difficult to schedule. This process of scheduling a DJ to play music at a particular venue can create issues for venue owners who seek to have a reliable DJ.

In the alternative, DJs who seek to promote their music may find it difficult to select a single venue from a plurality of venues at which to DJ on a particular night. In particular, some DJs may be invited to play music at several venues at the same time, or two geographically distant venues on consecutive days, making travel difficult.

### SUMMARY

In general terms, this disclosure is directed to remote streaming of content such as music.

In one aspect, a system for streaming music includes: a data communication network; a source venue for generating audio and video data stream, the source venue in communication with the data communication network; and at least one recipient venue, the at least one recipient venue in communication with the data communication network; wherein the source venue is configured to send the audio and video data stream to each recipient venue through the data communication network.

### DESCRIPTION OF THE DRAWINGS

FIG. 1 is a block diagram depicting an example remote DJ streaming network.

FIG. 2 is a block diagram illustrating the functionality of the remote DJ streaming network.

FIG. 3 is a flow chart illustrating an example process used by a recipient venue in a remote DJ streaming network.

FIG. 4 illustrates an example interface used by a DJ at the DJ venue.

FIG. 5 is another block diagram illustrating functionality of a remote broadcasting network.

FIG. 6 is a block diagram of a portion of the remote broadcasting network of FIG. 5 illustrating aspects of broadcasting.

FIG. 7 is a block diagram of a portion of the remote broadcasting network of FIG. 6 illustrating aspects of mixing video and audio sources.

FIG. 8 is a block diagram of a portion of the remote broadcasting network of FIG. 5 illustrating aspects of playback.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

The present disclosure relates to the live streaming of media content, such as audio music, from a source location or venue to one or more remotely located recipient venues. In one example embodiment, this disclosure is directed to the remote streaming of music played by a disc jockey (hereinafter referred to as “DJ”). Although the use of a DJ is referred to in various embodiments, any source of music may be used in implementation of the system, such as, but not limited to, a live band, group, or orchestra. In yet other examples, other types of media content can be captures and/or broadcast from one location to another locations. Examples of other media content include: interviews; parties and/or celebrations; events and festivals (e.g., holiday parties, weddings, etc.); venue events (e.g., at particular clubs, bars, etc.); sporting events; social media gatherings; etc.

Additionally, a bi-directional stream of a live video feed between the source venue and the one or more recipient venues is also disclosed. For example, multiple broadcasters/recipients can be located at remote locations. Each of the broadcast/recipients can broadcast and/or playback various video and/or audio feeds to/from the other broadcasters/recipients.

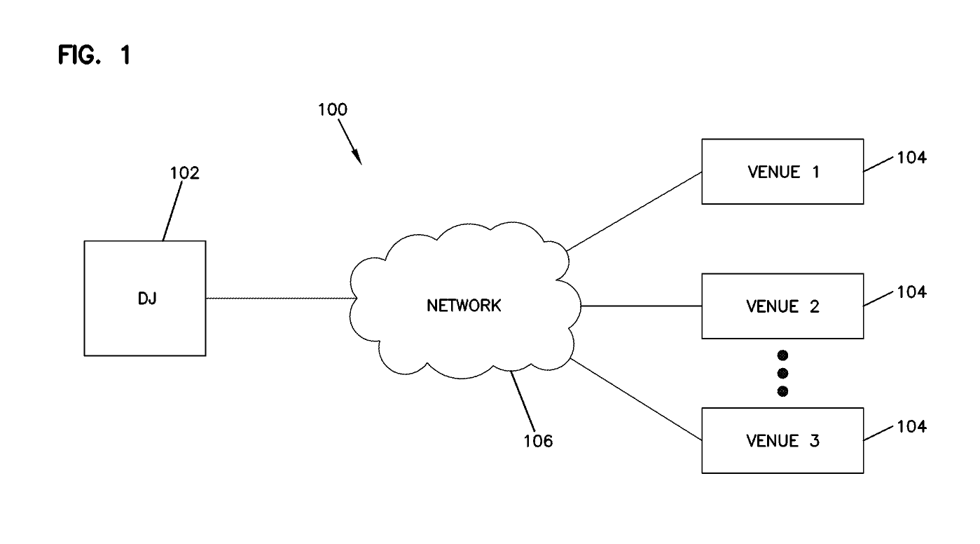

FIG. 1 is a block diagram depicting an example remote DJ streaming system 100. As illustrated, the system 100 includes a DJ venue 102 and one or more recipient venues 104. Generally, one or more computing devices located at the DJ venue 102 communicates with one or more computing devices located at the recipient venue 104 over a network 106, such as a local area network, wide area network, a wireless or cellular communication network, or the like.

In this example, the DJ venue 102 refers to the location from where the source music originates. For example, the DJ venue 102 may refer to where the DJ is streaming live music, such as a studio, a residence, a restaurant, a club, a stadium, or a bar. Accordingly, the DJ venue 102 includes equipment such as, for example, a computing device, a microphone, and a camera. In other embodiments, the equipment at the DJ venue 102 additionally includes a turntable, speakers, mixers, amplifiers, headphones, etc.

In this example, the recipient venue 104 refers to where the recipients of the DJ's audio and video streams are geographically located. As disclosed herein, the recipient venue 104 can be located virtually anywhere that can receive the DJ's live stream and can include venues such as, for example, a club, a bar, a restaurant, a stadium, or a residence.

As discussed herein, the DJ venue 102 is capable of sending audio and video streams to one or more recipient venues 104. Accordingly, each recipient venue 104 is capable of receiving and broadcasting, to a larger audience, a live video of the DJ and the associated music played and streamed by the DJ. In some embodiments, the DJ venue 102 only sends an audio stream to the recipient venue 104, thus allowing the recipient venue 104 to broadcast only music to the audience.

Similarly, each recipient venue 104 is capable of sending video streams to the DJ venue 102, thereby allowing the DJ to view the audience at each recipient venue 104. Thus, the DJ venue 102 is capable of receiving, and displaying, a live video of the recipient venue 104. In other embodiments, the recipient venue 104 is also capable of sending an audio stream to the DJ venue 102. Accordingly, the DJ can simultaneously view and hear each recipient venue 104 while streaming music, allowing the DJ to determine what types of music pleases the crowd, thereby effectively placing the DJ in the recipient venue 104.

Although this example embodiment describes a DJ located at the DJ venue 102, in other embodiments the DJ venue 102 may refer to a location where a band, group, or orchestra or other source of music or content is streaming the content and capable of receiving video and/or audio feed from each recipient venue 104.

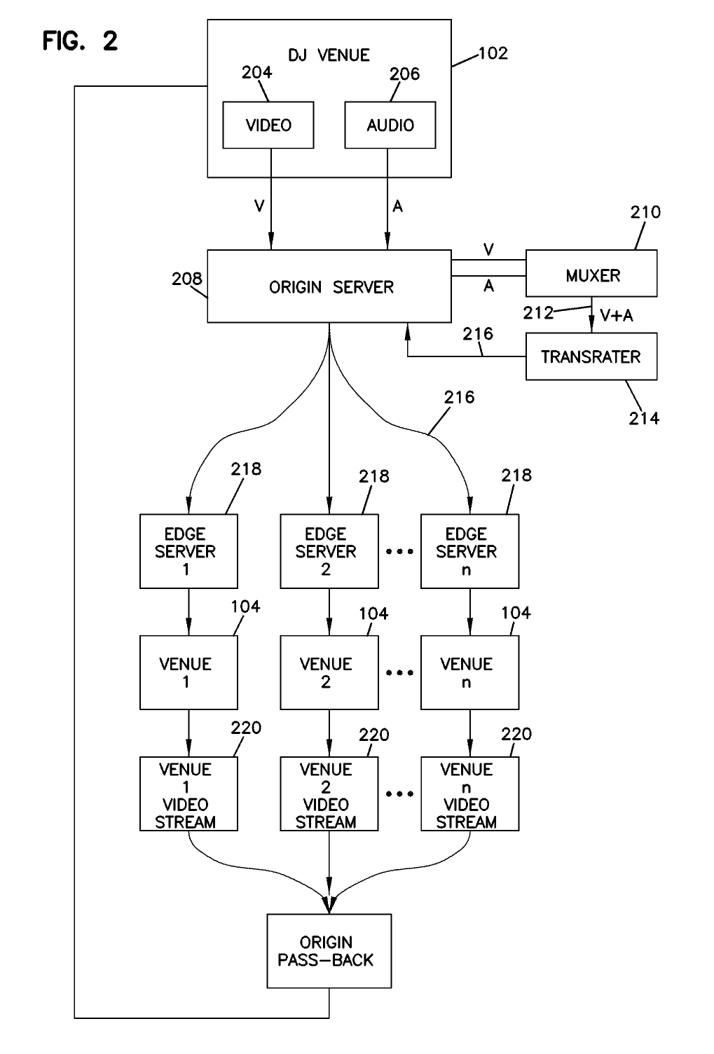

FIG. 2 is a block diagram illustrating the functionality of the remote DJ streaming network. As shown in this example, a DJ at the DJ venue 102 produces a video stream 204 and an audio stream 206, each having a specified bit rate. In some embodiments, the video stream 204 originates from a web camera or other type of camera capable of capturing video and streaming it over a network. In this embodiment, audio stream 206 originates from audio equipment such as a microphone. The video stream 204 and audio stream 206 each have metadata associating a time code for each bit of data produced.

In this example, where the video stream 204 and audio stream 206 are separate media streams, the video stream 204 and the audio stream 206 are both forwarded to an origin server 208 that is responsible for re-routing the signals to a multiplexer 210 over a network, as described with reference to FIG. 1. The multiplexer 210 is used to combine the video stream 204 and audio stream 206 into a single digital media stream 212 in order to conserve bandwidth. In this example, the multiplexer 210 aligns the video stream 204 and the audio stream 206 by aligning the time signals of each respective stream, thereby generating a properly aligned single digital media stream 212.

The combined digital media stream 212 is sent to a transrater 214, which encodes the digital media stream 212 into two or more variable bit streams (hereinafter referred to as “data stream 216”) to accommodate varying bandwidths supported by each recipient venue 104. In particular, the transrater 214 separates the digital media stream 212 into two or more data streams 216, each data stream 216 having a differing data rate and quality.

Example data rates include high quality data transfer rates of approximately 3000 kilobits per second (kbps), medium quality data transfer rates of approximately 1200 kbps, and low quality data rates of approximately 800 kbps. In some embodiments, the data streams 216 generated are determined based on preexisting knowledge of the bandwidth supported by each recipient venue 104 while in other embodiments, data streams 216 of commonly used data rates are generated.

Each of the generated data streams 216 are then routed back to the origin server 208, which thereafter routes the data streams 216 to one or more edge servers 218. In this example, each edge server 218 detects and requests one or more data streams 216 from the origin server 208 and transmits the requested data stream(s) 216 to an associated recipient venue 104 having the appropriate bandwidth and capability to play the received data stream 216. In alternative embodiments, however, the recipient venues 104 may detect and request a desired data stream 216 directly from the origin server 208.

Upon receipt of the data stream 216, each recipient venue 104 is capable of broadcasting to the audience, the video stream 204 of the DJ and the audio stream 206 of music played by the DJ. As additionally shown in this embodiment, the recipient venue 104, equipped with one or more cameras, generates a video stream 220 of the recipient venue 104. In some embodiments, the recipient venue 104 has a single camera focused on the audience, and in other embodiments, the recipient venue is equipped with multiple cameras focused on multiple areas of the recipient venue 104.

This video stream 220 is routed back to the DJ venue 102 through the origin server 208, thereby enabling the DJ to view the audience at the recipient venue 104. In some embodiments, the recipient venue 104 is additionally equipped with one or more microphones that generate an audio stream that can additionally be routed to the DJ venue 102, enabling the DJ to additionally hear the audience at the recipient venue 104.

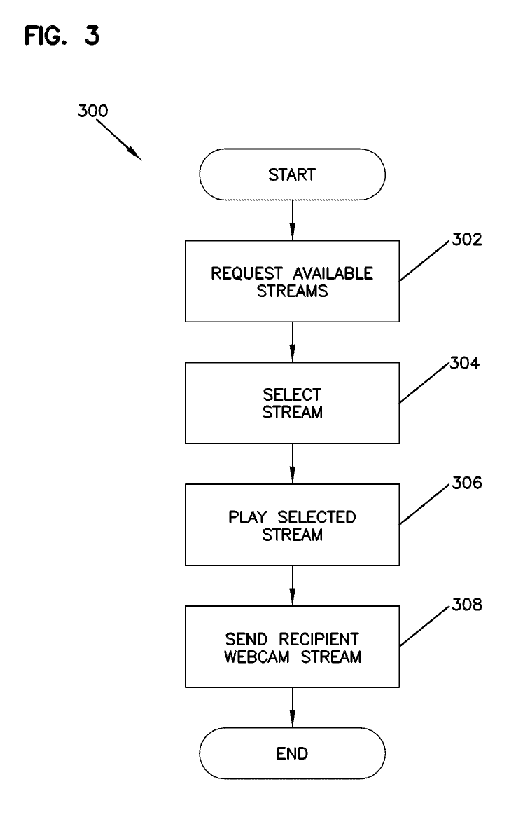

FIG. 3 is a flow chart illustrating an example process 300 used by a recipient venue 104 in a remote DJ streaming network. As shown, process begins with a requesting available streams operation 302 in which the recipient venue requests an available stream from the edge server, as described with reference to FIG. 2. In this example, the edge server transmits all of the available data streams to the recipient venue. Alternatively, the request includes the highest data rate supported by the recipient venue, thereby informing the edge server to transmit only those data streams that are supported by the recipient venue. In other embodiments, the edge server detects the data rate(s) supported by the recipient venue and sends only those supported data streams.

Flow proceeds to a selecting stream operation 304 in which the recipient venue selects a data stream from the plurality of data streams received from the edge server, depending on the recipient venue's availability of bandwidth and the bit rate associated with the data stream. In some embodiments, the recipient venue operates a quality of service poll at predetermined time intervals to perform a check of the recipient venue's bandwidth and throughput capabilities to determine whether the recipient venue can continue broadcasting the bit rate of the selected data stream. In some embodiments this check is performed every second and in other embodiments this check is performed more or less frequently.

If the check of the recipient venue's bandwidth indicates the recipient venue has a higher than previously determined bandwidth capability, the computing device can select a data stream of a higher quality, if available.

If, however, the computing device at the recipient venue loses bandwidth and is therefore unable to broadcast the selected data stream, the computing device selects a data stream of the next lowest quality that it can broadcast. In some embodiments, this selection is performed automatically by the computing device at the recipient venue, however in other embodiments, this is performed manually. In embodiments where the transition is performed automatically, the switch to the next lowest bandwidth occurs along matched time codes so the transition occurs smoothly. Accordingly, the image and sound quality presented to a person located at the recipient venue is unaffected during the switch.

Flow proceeds to the playing operation 306 in which the recipient venue broadcasts the selected data stream to the audience. In this example, this involves displaying, at the recipient venue, a video of the DJ on a screen and the streaming audio music on speakers. Alternatively, the recipient venue may choose to display only the audio music stream to the audience.

Flow proceeds to the sending recipient webcam stream operation 308 in which the recipient venue sends a webcam stream back to the DJ venue. In this embodiment, the recipient venue is equipped with a webcam that records and streams video of the recipient venue, thereby allowing the DJ located at the DJ venue to view the audience at the recipient venue. In some embodiments, the recipient venue is also equipped with a microphone and thus an audio stream from the recipient venue is also sent to the DJ.

Although only one recipient venue is shown and described herein, it is understood by one of ordinary skill in the art that the DJ can stream data to, and receive data from, multiple recipient venues. Accordingly, a remotely located DJ can interact with multiple recipient venues located in numerous regions of the world in real time.

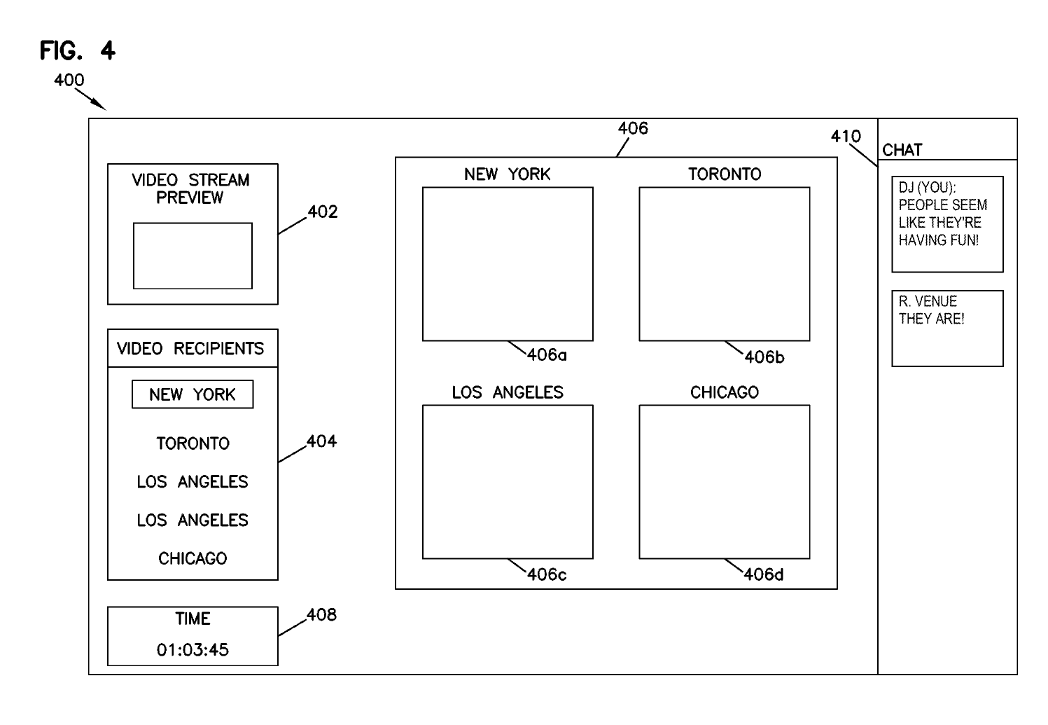

FIG. 4 illustrates an example interface 400 used by a DJ at the DJ venue 102. This user interface 400 is used by the DJ to communicate with each recipient venue 104. As shown, the example interface 400 includes a video stream preview 402, a list 404 of recipient venues to where the DJ is streaming music, a recipient venue video display 406, a timer 408, and a chat area 410.

In this example, the video stream preview 402 displays a video preview of the DJ that is sent to the recipient venue 104. This video preview facilitates the DJ in making adjustments to the camera in real time and also serves as a test to ensure the video stream is working properly.

As shown in this example, the list of recipient venues 404 indicates a list of all the cities in which the recipient venues reside. The list 404 may alternatively display a list of the recipient venue names, such as the name of a club or a bar and additional identifying information such as the city in which the venue is located or the address of the venue.

In this embodiment, the interface 400 includes a recipient venue display area 406, displaying a live video stream from each of the recipient venues. As shown, recipient venue display area 406 has a recipient display 406a-406d for each recipient venue. In some embodiments, the DJ may enlarge the display of an individual venue. This may be achieved by selecting an individual display, e.g., 406a for the New York venue, or alternatively by selecting the venue in the list 404. In this example, the selected recipient display, e.g., 406a may be enlarged such that it is the only venue displayed in the display area 406 or enlarged such that it is larger than the other recipient displays, e.g., 406b-d.

Also shown in this embodiment is a timer 408 that indicates the amount of time the DJ has been connected to a certain venue. In some embodiments, this timer indicates a total running time that the DJ has been connected to the first connected recipient venue. Alternatively, this timer 408 indicates the amount of time the DJ has been connected to a selected recipient venue.

This example interface 400 also includes a chat area 410 which allows the DJ to chat in real time with a manager or operator at each recipient venue. In some embodiments, this chat area 410 facilitates communication between the DJ and operators at each recipient venue. Alternatively, this chat area 410 facilities communication between only the DJ and the manager at a selected recipient venue.

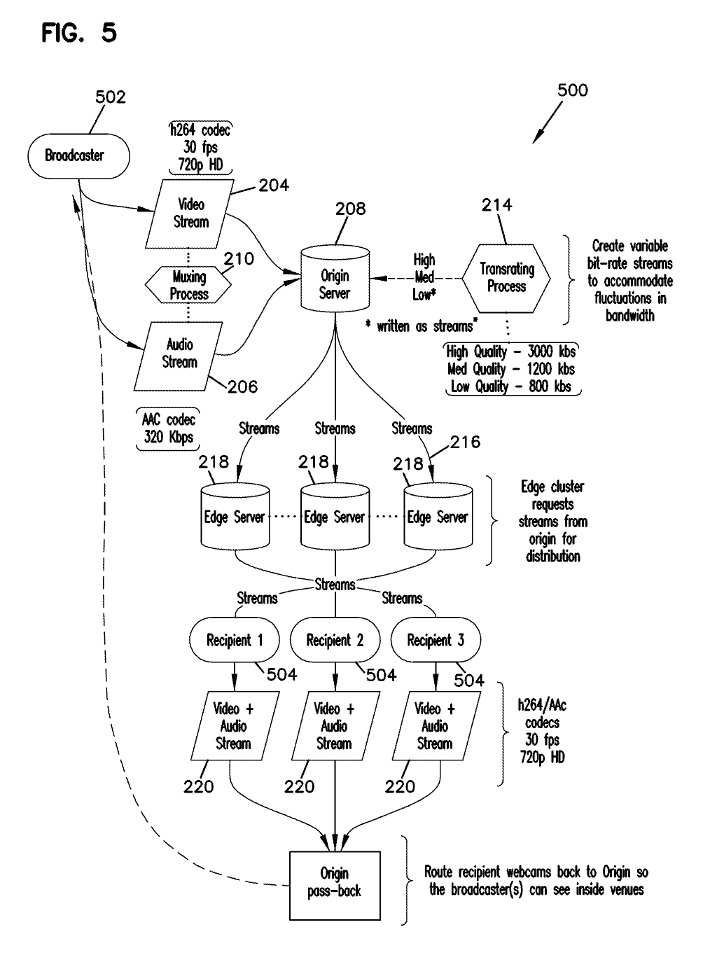

Referring now to FIGS. 5-8, another example remote broadcasting network system 500 is shown. The system 500 is similar to the system 100 described above. However, the system 100 allows each location (referred to as venue above) to: (i) broadcast media content, such as audio or video, to recipients at other locations; (ii) playback media content from broadcasters at other locations; and (iii) serially or simultaneously both broadcast and playback media content.

In FIG. 5, a broadcaster 502 is illustrated. As noted, this broadcaster 502 is located at a particular location, and the broadcaster 502 can broadcast media content to one or more remote locations. The broadcaster 502 accomplishes this using components that are very similar to the system 100 describe above.

However, the recipients 504 differ in that the recipients 504 can themselves both play back the media content and broadcast media content to the other recipients 504 and/or the broadcaster 502. In other words, each of the broadcaster 502 and recipients 504 can be both broadcasters and recipients.

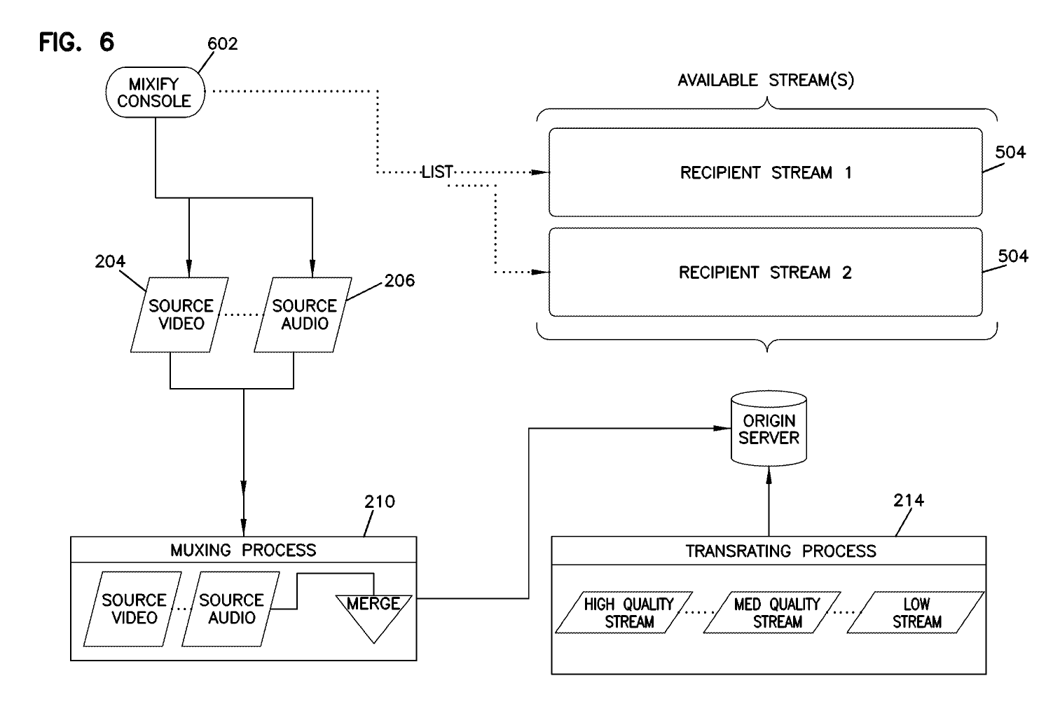

In FIG. 6, additional details regarding the broadcasting by the broadcaster 502 are provided. The broadcaster 502 uses a console 602, which can include an interface that is similar to the interface 400 described above. In this example, the console 602 allows the broadcaster 502 to control the broadcasting of content, including selecting which content is broadcast at any given time.

In addition, the multiplexer 210 depicted in FIG. 6 can be local to the client that is executing the console 602. In other words, both control and multiplexing of the media content can be performed by a single, local client. This allows for more efficient control of the media content prior to streaming to other locations.

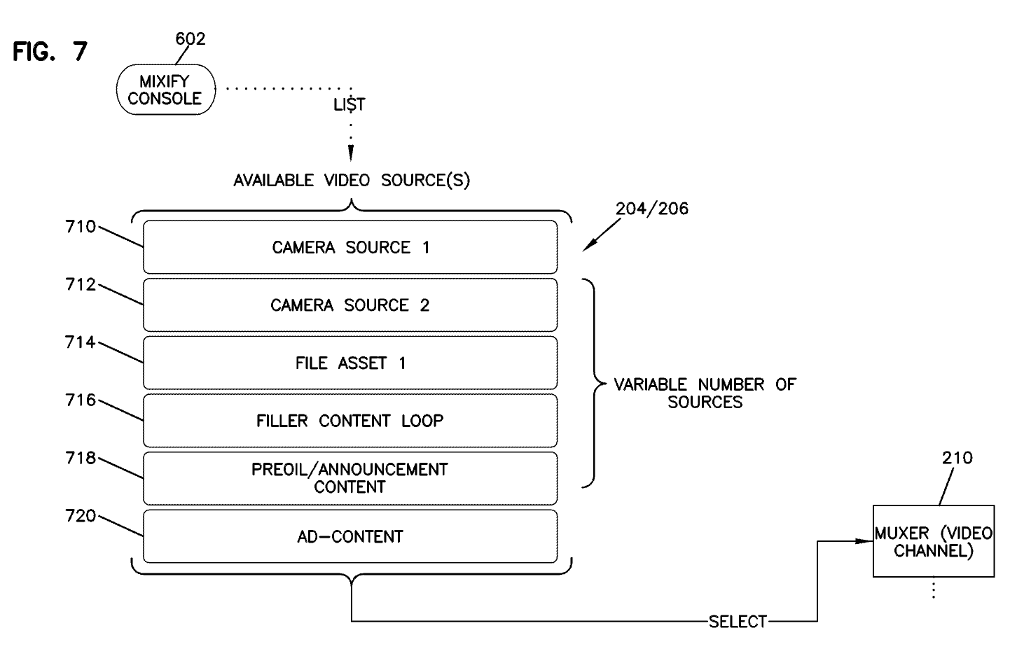

In FIG. 7, additional details regarding the selection of media content sources are provided. In this example, the console 602 is used to select between one or more media content sources. This variable number of media content sources can include, without limitation: camera sources 710, 712; various video and/or audio file assets 714; filler content loops 716; preroll/announcement content 718; and/or advertising content 720. These media content sources are selected by the broadcaster 502 using the console 602. The selected media content sources are passed to the multiplexer 210 for distribution by the system 500.

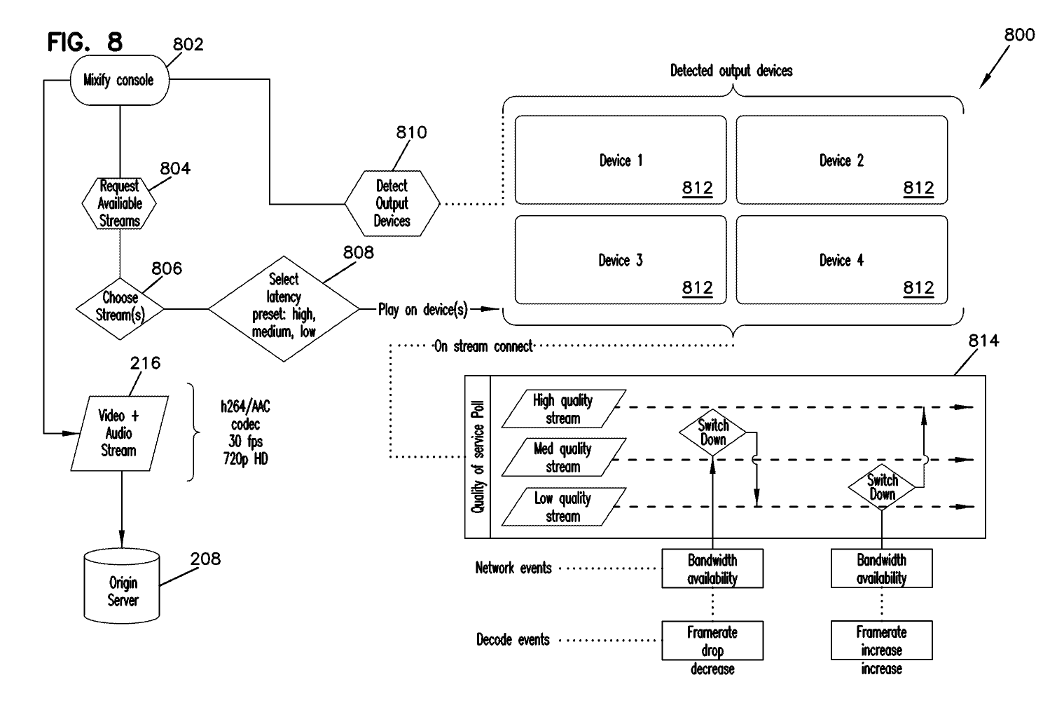

Referring now to FIG. 8, aspects of a playback portion 800 of the system 500 are shown. The recipient 504 uses a console 802 to review the available streams of media content at operation 804. The console 802 is configured at operation 810 to detect and receive media content from multiple devices 812.

At operation 806, the recipient can select one or more of the streams of media content. At operation 808, the recipient 504 selects a desired latency preset. This preset defines the desired latency for the media content and can include presets such as high (smooth playback with limited interruptions), medium (some latency is required for smooth playback), and low (almost no latency so that the content is served in near real time, such as for interviews and/or speaking engagements). The latency presets allow the system 500 to offer a wide variety of playback options to fit a variety of stream experience demands.

A decoder 814 examines attributes of each stream of media content, such as frame rate, to determine which quality stream to play. For example, if the source stream is 30 frames per second (fps) and the decoder 814 can only output 50 percent of the desired framerate of 30 fps (at 15 fps), the decoder 814 is configured to switch to a lower quality stream so that the full frames per second can be achieved. This may happen for various reasons, including network throughput and component limitations (e.g., slower computers and/or unaccelerated graphics cards).

The console 802 also allows the recipient 504 to control broadcasting of one or more streams of media content 216 through the origin server 208. In this manner, as described above, each location can both receive and broadcast. Such a system is advantageous to allow for flexibility. In this manner, each location can be both a broadcaster and recipient of media content as desired.

In the examples provided, the various components of the systems 100, 500 can be implemented on one or more computing devices. The computing devices can be configured in various ways, such as the traditional client/server configuration.

Each computing device can include various components, including a memory, a processing system, a secondary storage device, a network interface card, a video interface, a display unit, and an external component interface. In other embodiments, computing devices are implemented using more or fewer hardware components. For instance, in another example embodiment, a computing device does not include a video interface, a display unit, an external storage device, or an input device.

The term computer readable media as used herein may include computer storage media. Computer storage media may include volatile and nonvolatile, removable and non-removable media implemented in any method or technology for storage of information, such as computer readable instructions, data structures, program modules, or other data. The memory includes one or more computer storage media capable of storing data and/or instructions. As used in this document, a computer storage medium is a device or article of manufacture that stores data and/or software instructions readable by a computing device. In different embodiments, the memory is implemented in different ways. For instance, in various embodiments, the memory is implemented using various types of computer storage media. Example types of computer storage media include, but are not limited to, dynamic random access memory (DRAM), double data rate synchronous dynamic random access memory (DDR SDRAM), reduced latency DRAM, DDR2 SDRAM, DDR3 SDRAM, Rambus RAM, solid state memory, flash memory, read-only memory (ROM), electrically-erasable programmable ROM, and other types of devices and/or articles of manufacture that store data.

The processing system includes one or more physical integrated circuits that selectively execute software instructions. In various embodiments, the processing system is implemented in various ways. For example, the processing system can be implemented as one or more processing cores. In this example, the processing system can comprise one or more Intel microprocessors. In another example, the processing system can comprise one or more separate microprocessors.

The secondary storage device includes one or more computer storage media. The secondary storage device stores data and software instructions not directly accessible by the processing system. In other words, the processing system performs an I/O operation to retrieve data and/or software instructions from the secondary storage device. In various embodiments, the secondary storage device is implemented by various types of computer-readable data storage media. For instance, the secondary storage device may be implemented by one or more magnetic disks, magnetic tape drives, CD-ROM discs, DVD-ROM discs, Blu-Ray discs, solid state memory devices, Bernoulli cartridges, and/or other types of computer-readable data storage media.

The network interface card enables the computing device to send data to and receive data from a communication network. In different embodiments, the network interface card is implemented in different ways. For example, in various embodiments, the network interface card is implemented as an Ethernet interface, a token-ring network interface, a fiber optic network interface, a wireless network interface (e.g., WiFi, WiMax, etc.), or another type of network interface.

The video interface enables the computing device to output video information to the display unit. In different embodiments, the video interface is implemented in different ways. For instance, in one example embodiment, the video interface is integrated into a motherboard of the computing device. In another example embodiment, the video interface is a video expansion card. In various embodiments, the display unit can be a cathode-ray tube display, an LCD display panel, a plasma screen display panel, a touch-sensitive display panel, an LED screen, a projector, or another type of display unit. In various embodiments, the video interface communicates with the display unit in various ways. For example, the video interface can communicate with the display unit via a Universal Serial Bus (USB) connector, a VGA connector, a digital visual interface (DVI) connector, an S-Video connector, a High-Definition Multimedia Interface (HDMI) interface, a DisplayPort connector, or another type of connection.

The external component interface enables the computing device to communicate with external devices. In various embodiments, the external component interface is implemented in different ways. For example, the external component interface can be a USB interface, a FireWire interface, a serial port interface, a parallel port interface, a PS/2 interface, and/or another type of interface that enables the computing device to communicate with external devices. In different embodiments, the external component interface enables the computing device to communicate with different external components. For example, the external component interface can enable the computing device to communicate with external storage devices, input devices, speakers, phone charging jacks, modems, media player docks, other computing devices, scanners, digital cameras, a fingerprint reader, and other devices that can be connected to the computing device. Example types of external storage devices include, but are not limited to, magnetic tape drives, flash memory modules, magnetic disk drives, optical disc drives, flash memory units, zip disk drives, optical jukeboxes, and other types of devices comprising one or more computer storage media. Example types of input devices include, but are not limited to, keyboards, mice, trackballs, stylus input devices, key pads, microphones, joysticks, touch-sensitive display screens, and other types of devices that provide user input to the computing device.

The memory stores various types of data and/or software instructions. For instance, in one example, the memory stores a Basic Input/Output System (BIOS), and an operating system. The BIOS includes a set of software instructions that, when executed by the processing system, cause the computing device to boot up. The operating system includes a set of software instructions that, when executed by the processing system, cause the computing device to provide an operating system that coordinates the activities and sharing of resources of the computing device.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A system for streaming media content, comprising:
a data communication network;
a source venue for generating audio and/or video data stream, the source venue in communication with the data communication network; and
at least one recipient venue, the at least one recipient venue in communication with the data communication network;
wherein the source venue is configured to send the audio and/or video data stream to the at least one recipient venue through the data communication network.

2. The system of claim 1, wherein the source venue and the at least one recipient venue are in geographically different locations.

3. The system of claim 1, wherein:
the recipient venue generates a recipient video data stream; and
the recipient venue is configured to send the recipient video data stream to the source venue through the data communication network.

4. The system of claim 1, further comprising:
a multiplexer configured to combine the audio and/or video data stream into a single data stream; and
a transrater configured to generate, from the single data stream, at least two data streams having varying data rates.

5. The system of claim 1, wherein the audio and/or video data stream is captured from a disc jockey located at the source venue.

6. The system of claim 1, wherein the audio and/or video data stream includes both an audio stream with audio content and a video stream with video content.

7. The system of claim 6, further comprising a multiplexer to combine the audio content and the video content.

8. The system of claim 7, wherein the system is configured to transrate the audio and/or video data stream into multiple streams of differing quality.

9. A system for streaming media content, comprising:
a data communication network;
a first location for broadcasting a first audio and/or video data stream, the first location in communication with the data communication network; and
a second location for broadcasting a second audio and/or video data stream, the second location in communication with the data communication network;
wherein the first location is configured to both broadcast the first audio and/or video data stream and to playback the second audio and/or video data stream through the data communication network; and
wherein the second location is configured to both broadcast the second audio and/or video data stream and to playback the first audio and/or video data stream through the data communication network.

10. The system of claim 9, wherein the first and second locations are in geographically different locations.

11. The system of claim 9, further comprising:
a multiplexer configured to combine the first audio and/or video data stream into a single data stream; and
a transrater configured to generate, from the single data stream, at least two data streams having varying data rates.

12. The system of claim 9, wherein the first audio and/or video data stream is captured from a disc jockey located at the first location.

13. The system of claim 9, wherein the first audio and/or video data stream includes both an audio stream with audio content and a video stream with video content.

14. The system of claim 13, further comprising a multiplexer to combine the audio content and the video content.

15. The system of claim 14, wherein the system is configured to transrate the first audio and/or video data stream into multiple streams of differing quality.

16. A method for broadcasting and playing back media content, the method comprising:
receiving first media content from a first location;
multiplexing the first media content;
broadcasting the first media content to a plurality of other locations, including a second location;
receiving second media content from the second location;
multiplexing the second media content;
broadcasting the second media content to the plurality of other locations, including the first location;
allowing a user at the first location to control the broadcasting of the first media content; and
allowing the user to control playback of the second media content.

17. The method of claim 16, wherein the first and second locations are in geographically different locations.

18. The method of claim 16, further comprising:
multiplexing an audio component and a video component of the first media content into a single data stream; and
transrating the single data stream into at least two data streams having varying data rates.

19. The method of claim 18, further comprising capturing the first media content from a disc jockey.

20. The method of claim 16, further comprising capturing the first media content from a disc jockey.
